(19) United States
(12) Patent Application Publication
(10) Pub. No.: US 2017/0283960 A1
(43) Pub. Date: Oct. 5, 2017

(54) METHOD OF DISCOVERING FLUORO-CONTAINING COMPOUNDS

(71) Applicant: SHANXI CHEMICAL RESEARCH INSTITUTE CO., LTD., Taiyuan (CN)

(72) Inventors: Yao MA, Lexington, MA (US); Qing LIANG, TAIYUAN (CN); Weilin LI, TAIYUAN (CN); Yu TANG, TAIYUAN (CN); Weidong WEN, TAIYUAN (CN)

(73) Assignee: SHANXI CHEMICAL RESEARCH INSTITUTE CO., LTD., Taiyuan (CN)

(21) Appl. No.: 15/628,621

(22) Filed: Jun. 20, 2017

Related U.S. Application Data
(63) Continuation of application No. PCT/US2015/066957, filed on Dec. 20, 2015.
(60) Provisional application No. 62/095,055, filed on Dec. 21, 2014.

(51) Int. Cl. C25B 3/08; C01B 7/19

(52) U.S. Cl. CPC C25B 3/08; C01B 7/19

(57) ABSTRACT

The present teachings relate to a methods for drug discovery. In one particular example, the method includes providing a substrate, modifying the substrate by using an electrochemical fluorination, screening a reaction mixture of the electrochemical fluorination, and identifying a fluorinated compound in the reaction mixture.

### CROSS-REFERENCE TO RELATED APPLICATIONS

This application claims the benefit and priority to U.S. Provisional Application No. 62/095,055, filed on Dec. 21, 2014, the entire disclosure of which is incorporated herein by reference in its entirety.

### BACKGROUND

Drug discovery typically starts with a biological target or process that is causally connected with a medical condition. The biological target may include, for example: a protein, a peptide, a nucleotide, a nucleic acid, a carbohydrate, an assembly of the above, a membrane, a cell, and/or a tissue. Biological assays are then used to identify a compound or collection of compounds (“lead compound(s)”) that can affect the target or process.

Often, modifications are then made to the lead compound(s). These modifications may be made to investigate the relationship between the modifications and the activities in the biological assays (structure-activity relationship or “SAR”), test certain mechanisms of action, or explore chemical and/or biological intuitions. Based on the SAR or other processes, improvement can be made to the lead compounds, for example, to tune the affinity to the target, increase activity, improve the metabolic stability, increase the solubility, improve the cell membrane permeability, and etc. Eventually, a clinical candidate is identified.

One of the modifications often used by medicinal chemists is fluorination. Although fluorine ranks as the 13th most abundant element in the earth's crust, the presence of fluorine in naturally occurring organic compounds is exceedingly rare. It may be due to its high electro-negativity of fluorine and low oxidation potential of the fluoride ion. However, research since 1950's has proved that fluorine can produce favorable, sometimes surprisingly, therapeutic effect. As a result, in contrast to the very limited biosynthetic capabilities of nature for carbon-fluorine bond formation, chemists have developed an increasingly large collection of fluorination reactions. Current methods of fluorinating a drug lead structure may be based on organic synthesis reactions with a primary goal of producing a desired single synthetic product having a high yield. As a result, very often, the design of the structural modification is limited to known fluorination reactions at structural positions that may produce the desired single product in high yield. Accordingly, highly selective reactions are preferred for synthesizing the desired compound, one at a time. For a given drug lead compound, often there are only a few structural positions available for traditional modifications.

Methods are also available for making more than one structural modifications in the same reaction. A split synthesis technique may be implemented to make multiple products in a single reaction step. This technique has been used in drug discovery research. In the split synthesis process multiple parallel reactions are carried out, desired single product of each reaction are purified and are mixed together in the next reaction step to produce multiple products.

Although the split synthesis technique can make multiple products in a single reaction step, the technique has the limitation that the modification is done only at structural positions where each of the multiple starting materials can produce the desired single product in high yield.

Non-selective fluorination with fluorine gas has been used to improve drug discovery process. U.S. Pat. No. 8,815,781 teaches reacting donepezil, as well as other compounds, with fluorine gas, screening the reaction mixtures with an AChE enzyme, and identifying compounds with improved properties. However, direct fluorinations with fluorine gas have drawbacks. Among them, for example, are that the fluorinating reagents in such reaction are generally hazardous and direct fluorinations generally require substantial amount of starting materials.

Thus, there exists a need for methods that can more fully modify a drug lead structure for the discovery of fluorine-containing compounds with desirable drug properties.

### BRIEF SUMMARY

The present teachings generally relate to methods for drug discovery. One aspect of the present teachings relates to providing a substrate. One aspect of the present teachings relates to modifying the substrate by using an electrochemical fluorination. One aspect of the present teachings relates to screening a reaction mixture of the electrochemical fluorination. One aspect of the present teachings relates to identifying a fluorinated compound in the reaction mixture.

One aspect of the present teachings relates to providing a substrate, modifying the substrate by using an electrochemical fluorination, screening a reaction mixture of the electrochemical fluorination, and identifying a fluorinated compound in the reaction mixture.

For example, an aspect of the present teachings relates to a method of identifying a compound that includes providing a substrate; modifying the substrate with an electrochemical fluorination to providing a reaction mixture; and screening the reaction mixture against a biological target.

In various embodiments, the substrate is a small molecule. In certain embodiments, the substrate is a therapeutic agent. For example, the substrate can be an approved therapeutic agent, a therapeutic agent in a clinical trial, a therapeutic agent in a preclinical study, or a therapeutic agent that has been withdrawn from the market. In particular embodiments, the substrate is Sorafenib, Rosiglitazone, Erlotinib, Metaxalone, PIK-293, WP1066, R406, Telmisartan, XL147, CGI1746, Regorafenib, Alisertib, Axitinib, ZSTK474, Tofacitinib, JNJ-38877605, BEZ235, CAL-101, Ruxolitinib, DF-04691502, BKM120, Dabrafenib, VX-702, Ibrutinib (PCI-32765), CUDC-101, Trametinib, PF-04691502, IC-87114, Cabozantinib, Selumetinib, PKI402, AVL-292, PIK294, GDC-0994, Olanzapine, Lenvatinib, Pazopanib, PH-797804, Sotrastaurin, Cediranib, Linezolid, TG100-115, Brivanib (BMS-540215), LY294002, or Selumetinib (AZD6244).

In various embodiments, the method includes preparing a reaction solution. In some embodiments, the reaction solution includes the substrate. In some embodiments, the reaction solution includes a fluorinating source.

In certain embodiments, the fluorinating source includes hydrogen fluoride. For example, the hydrogen fluoride is substantially anhydrous. In some embodiments, the fluorinating source includes a fluoride salt. In some embodiments, the fluorinating source includes a fluoride compound. For example, the fluorinating source is anhydrous hydrogen fluoride, fluorine (F₂), LiF, KF, NaF, CsF, AgF₂, CuF₂, FClO₃, SF₄, XeF₂, AcOF, (PhSO₂)₂NF, Et₂NSF₃, Et₃N.(HF)₂₋₅, Et₄NF.(HF)₂₋₅, Et₄N.BF₄, (PhSO₂)₂NF (NFSI), N-fluoro-o-benzenedisulfonimide (NFOBS), Et₂NSF₃ (DAST), (MeOCH₂CH₂)₂NSF₃ (Deoxofluor®), 1-chloromethyl-4-fluoro-1,4-diazoniabicyclo[2,2,2]octane bis(tetrafluoroborate) (Selectfluor®), 4-tert-butyl-2,6-dimethylphenylsulfur trifluoride (Fluolead®), N-fluoropyridinium triflate, or N-fluoropyridinium tetrafluoroborate. In particular embodiments, the fluorinating source is anhydrous hydrogen fluoride, LiF, KF, NaF, CsF, Et₃N.(HF)₂₋₅, Et₄NF.(HF)₂₋₅, Et₄N.BF₄, N-fluoropyridinium triflate, or N-fluoropyridinium tetrafluoroborate.

In various embodiments, the reaction solution includes a phase transfer additive. In various embodiments, the reaction solution includes an electrolytic phase. In various embodiments, the reaction solution includes a fluorochemical phase. In various embodiments, the reaction solution includes a solvent. For example, the solvent can be acetonitrile, methylene chloride, 1,2-dimethoxyethane, or nitromethane.

In various embodiments, the electrochemical fluorination is conducted in the presence of a cathode and an anode. In some embodiments, the cathode is made of a material comprising Ni, Fe, Cu, Pt, an alloy thereof, or C. In some embodiments, the anode is made of a material comprising Al, Co, Cr, Cu, Mg, Ti, Zn, Zr, Fe, Co, Ni, Pt, or an alloy thereof. In certain embodiments, the cathode is made of a material comprising Ni or Pt. In certain embodiments, the anode is made of a material comprising Ni or Pt.

In various embodiments, the electrochemical fluorination is conducted at about 25° C. In various embodiments, the electrochemical fluorination is conducted at the atmospheric pressure. In various embodiments, the electrochemical fluorination is conducted with a cyclic electric current. In various embodiments, the electrochemical fluorination is conducted with a constant electric current.

In various embodiments, the electrochemical fluorination is conducted until a conversion of at least 5% is reached. For example, the conversion can be at least 50%. In various embodiments, the electrochemical fluorination is conducted until a conversion of no more than 10% is reached. For example, the conversion can be no more than 5%.

In various embodiments, the electrochemical fluorination is allowed to proceed until a product is detected. In various embodiments, the conditions of an ECF of the present teachings are adjusted so that mono-fluorinated compounds (i.e., each of which has only one carbon-bound hydrogen replaced by fluorine) are produced. In some embodiments, the ECF produces one mono-fluorinated compound. In some embodiments, the ECF produces two mono-fluorinated compounds. In some embodiments, the ECF produces three or more mono-fluorinated compounds.

In various embodiments, the electrochemical fluorination is allowed to proceed before other products are detected. In some embodiments, the other products include mono-fluorinated compounds. In some embodiments, the other products include di-fluorinated compounds. In some embodiments, the other products include multi-fluorinated compounds. In certain embodiments, the other products include derivatives of a mono-fluorinated compound, a di-fluorinated compound, or a multi-fluorinated compound.

In various embodiments, a method of the present teachings includes contacting a reaction mixture from an electrochemical fluorination with a biological target. For example, the biological target can be a protein. In some embodiments, the protein is a kinase, a protease, a peptidase, a nuclear hormone receptor, a protein complex, a G-protein coupled receptor (GPCR), a protein-protein interaction target, or a transcription factor.

In various embodiments, a method of the present teachings includes screening a reaction mixture of an electrochemical fluorination of the present teachings with an automated ligand identification system (ALIS), SpeedScreen, a frontal affinity chromatography, an affinity capture, an affinity capillary electrophoresis, an ultra-filtration, or a pulsed ultra-filtration. In some embodiments, the method includes screening the reaction mixture with a frontal affinity chromatography, an affinity capillary electrophoresis, or an ultra-filtration. In certain embodiments, a MiniSpin™ column is used in the screening. In some embodiments, the method includes detecting a component with mass spectrometry. For example, MS can be used to identify a desirable component in the reaction mixture. In certain embodiments, the desirable component has an improved property from the substrate. In certain embodiments, the desirable component has a different but useful property from the substrate.

In various embodiments, the method includes confirming a biological activity of a desirable component.

Another aspect of the present teachings relates to a compound identified by a method described herein. Yet another aspect of the present teachings relates to a system that can be used with a method described herein.

### BRIEF DESCRIPTION OF DRAWINGS

The following drawings form part of the present teachings and are included to demonstrate further certain aspects of the present teachings. The present teachings may be better understood by reference to one or more of these drawings in combination with the detailed description of specific embodiments presented herein.

FIGS. 1A and 1B show two exemplary ECF cells.

FIGS. 2A-2D show exemplary LC-MS chromatograms of an exemplary reaction mixture from Example 1 before the reaction was commenced.

FIGS. 3A-3D show exemplary LC-MS chromatograms of an exemplary reaction mixture from Example 1 approximately 10 hours after the reaction was commenced.

FIGS. 4A-4D show exemplary LC-MS chromatograms of an exemplary reaction mixture from Example 2 before the reaction was commenced.

FIGS. 5A-5D show exemplary LC-MS chromatograms of an exemplary reaction mixture from Example 2 approximately 22 hours after the reaction was commenced.

FIGS. 6A-6D show exemplary LC-MS chromatograms of an exemplary reaction mixture from Example 3 before the reaction was commenced.

FIGS. 7A-7D show exemplary LC-MS chromatograms of an exemplary reaction mixture from Example 3 approximately 10 hours after the reaction was commenced.

FIGS. 8A-8B show exemplary LC-MS chromatograms of an exemplary reaction mixture from Example 3 treated with a PBS solution according to Example 4.

FIGS. 9A-9B show exemplary LC-MS chromatograms of an exemplary eluent from a spin column after a mixture of an exemplary reaction mixture from Example 3 treated with a PBS solution was treated with the spin column according to Example 4.

FIGS. 10A-10B show exemplary LC-MS chromatograms of an exemplary eluent from a spin column after a mixture of an exemplary reaction mixture from Example 3 treated with a VEGFR-2 solution was treated with the spin column according to Example 4.

### DETAILED DESCRIPTION

In the present teachings, where an element or component is said to be included in and/or selected from a list of recited elements or components, it should be understood that the element or component can be any one of the recited elements or components, or can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “a,” “an,” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the teachings and does not pose a limitation on the scope of the claims. No language in the specification should be construed as indicating any non-claimed element as essential to the practice of the present teachings.

The phrase “and/or,” as used herein, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements).

As used herein, “or” should be understood to have the same meaning as “and/or” as defined herein. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the phrase “at least one” in reference to a list of one or more elements should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of the terms “comprise,” “comprises,” “comprising,” “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

All numerical ranges herein include all numerical values and ranges of all numerical values within the recited range of numerical values. As a non-limiting example, (C₁-C₆) alkyls also include any one of C₁, C₂, C₃, C₄, C₅, C₆, (C₁-C₂), (C₁-C₃), (C₁-C₄), (C₁-C₅), (C₂-C₃), (C₂-C₄), (C₂-C₅), (C₂-C₆), (C₂-C₄), (C₂-C₅), (C₃-C₆), (C₄-C₅), (C₄-C₆), and (C₅-C₆) alkyls.

Further, while the numerical ranges and parameters setting forth the broad scope of the disclosure are approximations as discussed above, the numerical values set forth in the Examples section are reported as precisely as possible. It should be understood, however, that such numerical values inherently contain certain errors resulting from the measurement equipment and/or measurement technique.

It should be understood that the order of steps or order for performing certain actions is immaterial so long as the present teachings remain operable. Moreover, two or more steps or actions may be conducted simultaneously.

As used herein, the terms “therapeutic agent” and “therapeutic agents” refer to any agent(s) which can be used to furnish pharmacological activity or other direct effect in the diagnosis, cure, mitigation, treatment, or prevention of disease or to affect the structure or any function of the human body. In certain embodiments, the term “therapeutic agent” includes a compound provided herein. In certain embodiments, a therapeutic agent is an agent which is known to be useful for, or has been or is currently being used for the treatment or prevention of a disorder or one or more symptoms thereof.

The term “approved,” when used in connection with a therapeutic agent, means that an application to market the therapeutic agent has been submitted to the Drug and Food Administration (FDA) of the United States or an equivalent governmental body and the application has been evaluated and approved by FDA or the equivalent thereof.

The term “clinical trial,” when used in connection with a therapeutic agent, refers to any research study that prospectively assigns human participants or groups of humans to one or more health-related interventions to evaluate the effects of the therapeutic agent on health outcomes. Any research study to use subjects other than human to evaluate the effects of the therapeutic agent is a preclinical study.

The term “small molecule”, as used herein, generally refers to an organic molecule that is less than 2000 g/mol in molecular weight, less than 1500 g/mol, less than 1000 g/mol, less than 800 g/mol, or less than 500 g/mol.

The term “molecular weight”, as used herein, generally refers to the mass or average mass of a molecule of a material.

A dash (“-”) that is not between two letters or symbols is used to indicate a point of attachment for a substituent. For example, —CONH₂ is attached through the carbon atom (C).

The term “alkane” refers to a saturated aliphatic hydrocarbon compound, including a straight-chain alkane, branched-chain alkane, cycloalkane, alkyl-substituted cycloalkane, and cycloalkyl-substituted alkane, that has 30 or fewer carbon atoms in its backbone (e.g., C₁-C₃₀ for straight chains, C₃-C₃₀ for branched chains). In some embodiments, the alkane has 20 or fewer, 12 or fewer, or 7 or fewer carbon atoms in its backbone.

The terms “alkene” and “alkyne” refer to unsaturated aliphatic analogous in length and possible substitution to the alkane described above, but that contain at least one double or triple bond respectively.

The term “aromatic” refers to C₅-C₂₀-membered aromatic, heterocyclic, fused aromatic, fused heterocyclic, biaromatic, or bihetereocyclic compound.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C₁-C₃₀ for straight chains, C₃-C₃₀ for branched chains), 20 or fewer, 12 or fewer, or 7 or fewer. Likewise, in some embodiments, cycloalkyls have from 3-10 carbon atoms in their ring structure, e.g. have 5, 6, or 7 carbons in the ring structure. The term “alkyl” (or “lower alkyl”) as used throughout the specification, examples, and claims is intended to include both “unsubstituted alkyls” and “substituted alkyls,” the latter of which refers to alkyl moieties having one or more substituents, such as those described herein, replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, aromatic, or heteroaromatic moiety.

Unless the number of carbons is otherwise specified, “lower alkyl” as used herein means an alkyl group, as defined above, but having from one to ten carbons, or from one to six carbon atoms in its backbone structure. Likewise, “lower alkenyl” and “lower alkynyl” have similar chain lengths. Throughout the present teachings, preferred alkyl groups are lower alkyls. In some embodiments, a substituent designated herein as alkyl is a lower alkyl.

It will be understood by those skilled in the art that the moieties substituted on the hydrocarbon chain can themselves be substituted, if appropriate, with one or more substituents, each of which is discussed herein. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted with one or more substituents, each of which is discussed herein.

The term “alkylthio” refers to an alkyl group, as defined above, having a sulfur radical attached thereto. In some embodiments, the “alkylthio” moiety is represented by one of —S— alkyl, —S-alkenyl, and —S-alkynyl. Representative alkylthio groups include methylthio and ethylthio. The term “alkylthio” also encompasses cycloalkyl groups, alkenyl and cycloalkenyl groups, and alkyne groups. “Arylthio” refers to aryl or heteroaryl groups. Alkylthio groups can be substituted with one or more substituents, each of which is discussed herein.

The terms “alkenyl” and “alkynyl”, refer to unsaturated aliphatic groups analogous in length and possible substitution to the alkyls described above, but that contain at least one double or triple bond respectively.

The terms “alkoxyl” or “alkoxy” as used herein refers to an alkyl group, as defined above, having an oxygen radical attached thereto. Representative alkoxyl groups include methoxy, ethoxy, propyloxy, and tert-butoxy. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, and —O— alkynyl. Aroxy can be represented by —O-aryl or O-heteroaryl, wherein aryl and heteroaryl are as defined below. The alkoxy and aroxy groups can be substituted as described with one or more substituents, each of which is discussed herein.

The terms “amine” and “amino” are art-recognized and refer to both unsubstituted and substituted amines, e.g., a moiety that can be represented by the general formula:

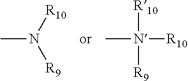

wherein R₉, R₁₀, and R′₁₀ each independently represent a hydrogen, an alkyl, an alkenyl, —(CH₂)ₘ—R₈, or R₉ and R₁₀ taken together with the N atom to which they are attached complete a heterocycle having from 4 to 8 atoms in the ring structure; R₈ represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R′₁₀) each independently represent a hydrogen, an alkyl or cycloalkyl, an alkenyl or cycloalkenyl, or alkynyl. Thus, the term “alkylamine” as used herein means an amine group, as defined above, having a substituted (with one or more substituents, each of which is discussed herein) or unsubstituted alkyl attached thereto, i.e., at least one of R₉ and R₁₀ is an alkyl group.

The term “amido” is art-recognized as an amino-substituted carbonyl and includes a moiety that can be represented by the general formula:

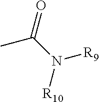

wherein R₉ and R₁₀ are as defined herein.

“Aryl”, as used herein, refers to C₅-C₁₀-membered aromatic, heterocyclic, fused aromatic, fused heterocyclic, biaromatic, or bihetereocyclic ring systems. Broadly defined, “aryl”, as used herein, includes 5-, 6-, 7-, 8-, 9-, and 10-membered single-ring aromatic groups that may include from zero to four heteroatoms, for example, benzene, pyrrole, furan, thiophene, imidazole, oxazole, triazole, triazole, pyrazole, pyridine, pyrazine, pyridazine and pyrimidine, and the like. Those aryl groups having heteroatoms in the ring structure may also be referred to as “aryl heterocycles,” “heteroaromatics,” or “heteroaryl.” The aromatic ring can be substituted at one or more ring positions with one or more substituents with one or more substituents, each of which is discussed herein. For example, the one or more substituents can include, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3 b]tetrahydrofuranyl, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazolyl, pyridoimidazolyl, pyridothiazolyl, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl”.

The term “aralkyl”, as used herein, refers to an alkyl group substituted with an aryl group (e.g., an aromatic or heteroaromatic group).

The term “carbocycle”, as used herein, refers to an aromatic or nonaromatic ring in which each atom of the ring is carbon.

“Heterocycle” or “heterocyclic”, as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) wherein Y is absent or is H, O, (C₁-C₁₀)alkyl, phenyl or benzyl, and optionally containing 1-3 double bonds and optionally substituted with one or more substituents, each of which is discussed herein. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazolyl, pyridoimidazolyl, pyridothiazolyl, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl, and xanthenyl. Heterocyclic groups can optionally be substituted at one or more positions with one or more substituents, each of which is discussed herein, including, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, and —CN.

The term “carbonyl” is art-recognized and includes such moieties as can be represented by the general formula:

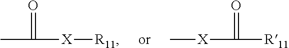

wherein X is a bond or represents an oxygen or a sulfur, and R₁₁ represents a hydrogen, an alkyl, a cycloalkyl, an alkenyl, a cycloalkenyl, or an alkynyl, R′₁₁ represents a hydrogen, an alkyl, a cycloalkyl, an alkenyl, a cycloalkenyl, or an alkynyl. Where X is an oxygen and R₁₁ or R′₁₁ is not hydrogen, the formula represents an “ester.” Where X is an oxygen and R₁₁ is as defined above, the moiety is referred to herein as a carboxyl group, and particularly when R₁₁ is a hydrogen, the formula represents a “carboxylic acid.” Where X is an oxygen and R′₁₁ is hydrogen, the formula represents a “formate.”

In general, where the oxygen atom of the above formula is replaced by sulfur, the formula represents a “thiocarbonyl” group. Where X is a sulfur and R₁₁ or R′₁₁ is not hydrogen, the formula represents a “thioester.” Where X is a sulfur and R₁₁ is hydrogen, the formula represents a “thiocarboxylic acid.” Where X is a sulfur and R′₁₁ is hydrogen, the formula represents a “thioformate.” On the other hand, where X is a bond, and R₁₁ is not hydrogen, the above formula represents a “ketone” group. Where X is a bond, and R₁₁ is hydrogen, the above formula represents an “aldehyde” group.

The term “heteroatom” as used herein means an atom of any element other than carbon or hydrogen. Examples of heteroatoms are boron, nitrogen, oxygen, phosphorus, sulfur, and selenium. Other heteroatoms include silicon and arsenic.

As used herein, the term “nitro” means —NO₂; the term “halogen” designates —F, —Cl, —Br, or —I; the term “sulfhydryl” means —SH; the term “hydroxyl” means —OH; and the term “sulfonyl” means —SO₂—.

As used herein, “fluorinated” refers to chemical compounds each having at least one carbon-bonded hydrogen replaced by a fluorine (—F), and can include perfluorinated compounds.

As used herein, “perfluorinated” compounds refer to chemical compounds in which essentially all carbon-bonded hydrogens have been replaced by fluorines (—F), although typically some residual hydride will be present in a perfluorinated composition.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, aminoacid, peptide, and polypeptide groups.

Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

The permissible substituents can be one or more and the same or different for appropriate organic compounds. The heteroatoms such as nitrogen may have hydrogen substituents and/or any permissible substituents of organic compounds described herein which satisfy the valencies of the heteroatoms.

In various embodiments, the substituent is alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, or thioketone, each of which optionally is substituted with one or more suitable substituents. In some embodiments, the substituent is alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, or thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

The “Simons process” or the “Simons electrochemical fluorination process” is a process for fluorinating a substrate dissolved or dispersed in liquid, anhydrous, hydrogen fluoride (HF). Simons electrochemical fluorination can be carried out essentially as follows: A substrate and an optional conductivity additive are dispersed or dissolved in anhydrous hydrogen fluoride to form a “reaction solution.” As used herein, the term “reaction solution” includes any homogenous or heterogeneous mixture of any of gaseous substances, liquid substances, and solid substances. One or more anodes and one or more cathodes are placed in the reaction solution and an electric potential (voltage) is established between the anode(s) and cathode(s), causing electric current to flow between the cathode and anode, through the reaction solution, and resulting in fluorination, i.e., replacement of one or more carbon-bonded hydrogens with carbon-bonded fluorines at the anode, and a reduction reaction (primarily hydrogen evolution) at the cathode.

As used herein, “electric current” refers to electric current in the conventional meaning of the phrase, the flow of electrons, and also refers to the flow of positively or negatively charged chemical species (ions); while wishing not to be bound by theory, it is believed that the current flowing through the reaction solution in the process is significantly a flow of such ionic chemical species through the reaction solution.

The term “interrupted,” when used with respect to an electrical parameter (e.g., current, current density, voltage, power, etc.), describes a periodic change in the value of that parameter through a regular, repeating, or cycle.

The term “cycle,” as in current cycle, voltage cycle, or power cycle, etc., refers to a single, complete execution through the different levels through which the parameter varies. As an example, a current cycle describes a single execution through various levels of current that pass through a fluorination cell, beginning at a starting current level (taken as any arbitrarily chosen point of the cycle), continuing through operation at one or more other current levels, and returning to the starting point at the initial current level.

The term “current density” is defined as the current in amps passing through the reaction solution measured at an active site of the anode or anodes divided by the area of the anode or anodes.

The term “conversion,” when used in connection with electrochemical fluorination, refers to the amount of substrate consumed in the electrochemical fluorination. For example, the conversion can be represented by the percentage (%) of the remaining amount of a substrate in the reaction solution at a given time.

In one aspect, the present teachings relate to a method of providing a substrate, modifying the substrate by using an electrochemical fluorination, screening a reaction mixture of the electrochemical fluorination, and identifying a fluorinated compound in the reaction mixture. The process can be practiced according to methods similar to electrochemical fluorination methods generally known as the “Simons” electrochemical fluorination.

The Simons process is well-known, and the subject of numerous technical publications. An early patent describing the Simons process is U.S. Pat. No. 2,519,983 (Simons), which contains a drawing of a Simons cell and its appurtenances. A description and photograph of laboratory and pilot plant-scale electrochemical fluorination cells suitable for practicing the Simons process appear at pages 416-418 of vol. 1 of “Fluorine Chemistry,” edited by J. H. Simons, published in 1950 by Academic Press, Inc., New York. U.S. Pat. No. 5,322,597 (Childs et al.) and U.S. Pat. No. 5,387,323 (Minday et al.) each refer to the Simons process and Simons cell. Further, electrochemical fluorination by the Simons process is described by Alsmeyer et al., Electrochemical Fluorination and Its Applications, Organofluorine Chemistry: Principles and Commercial Applications Chapter 5, pp. 121-43 (1994); S. Nagase in Fluorine Chem. Rev., 1 (1) 77-106 (1967); and J. Burdon and J. C. Tatlow, The Electrochemical Process for The Synthesis of Fluoro-Organic Compounds, Advances in Fluorine Chemistry, edited by M. Stacey et al., (1960).

In various embodiments, the method includes providing a substrate. The substrate can be any chemical compound or composition that comprises a carbon-bonded hydrogen. In various embodiments, the substrate is combined with hydrogen fluoride (optionally in the presence of a conductivity additive) to prepare a reaction solution through which electric current can be passed to cause fluorination of the substrate. In some embodiments, the substrate includes an organic compound. For example, the organic compound can be a small molecule or a large molecule.

In some embodiments, the substrate includes a hydrocarbon optionally substituted with at least one substituent described herein. For example, the substrate can be an unsubstituted hydrocarbon compound or a hydrocarbon compound substituted with one, two, three, four, five, six, seven, seven, eight, nine, or ten permissible substituents, each of which independently is described herein. In certain embodiments, the substrate is an alkane, alkene, alkyne, or aromatic, each of which optionally is substituted with one, two, three, four, five, six, seven, seven, eight, nine, or ten permissible substituents, each of which independently is described herein.

In certain embodiments, the substrate is a therapeutic agent. In particular embodiments, the substrate is an approved therapeutic agent. In particular embodiments, the substrate is a therapeutic agent in clinical trial. In particular embodiments, the substrate is a therapeutic agent in preclinical testing. In particular embodiments, the substrate is a therapeutic agent that has been withdrawn from the market. In various embodiments, the substrate is Sorafenib, Rosiglitazone, Erlotinib, Metaxalone, PIK-293, WP1066, R406, Telmisartan, XL147, CGI1746, Regorafenib, Alisertib, Axitinib, ZSTK474, Tofacitinib, JNJ-38877605, BEZ235, CAL-101, Ruxolitinib, DF-04691502, BKM120, Dabrafenib, VX-702, Ibrutinib (PCI-32765), CUDC-101, Trametinib, PF-04691502, IC-87114, Cabozantinib, Selumetinib, PKI402, AVL-292, PIK294, GDC-0994, Olanzapine, Lenvatinib, Pazopanib, PH-797804, Sotrastaurin, Cediranib, Linezolid, TG100-115, Brivanib (BMS-540215), LY294002, or Selumetinib (AZD6244). Without intending to limit the scope of the enclosed claims, Rosiglitazone, Telmisartan, and Sorafenib are included herein as three exemplary substrates to illustrate the present teachings.

In various embodiments, a method of the present teachings includes providing a single substrate. In various embodiments, the method includes providing two or more substrates. Solely for the convenience of illustration and not wishing to limit the scope of the present teachings, the description herein uses a substrate. And a person with ordinary skills in the art would know that this present teachings equally apply to two or more substrates.

In various embodiments, a method of the present teachings includes modifying a substrate described herein by using an electrochemical fluorination. The modification can include preparing a reaction solution.

In various embodiments, the reaction solution includes a fluorinating source and a substrate. The fluorinating source in general is any reagent that is capable to produce a fluorine species, for example, fluoride ion (F⁻), in situ in an electrochemical reaction. For example, the fluorinating source can be hydrogen fluoride, a fluoride salt, a fluorinated compound (e.g., an organic fluoride), a fluoride complex, or a mixture thereof. In some embodiments, the fluorinating source includes hydrogen fluoride. In certain embodiments, the hydrogen fluoride is substantially anhydrous, meaning that it contains at most only a minor amount of water, including, less than about 1 weight percent (wt %) water.

In some embodiments, the fluorinating source includes a fluoride salt. In certain embodiments, the fluorinating source includes an organic cation as a counter ion. In particular embodiments, the organic cation in the fluorinating source is obtained from an amine or a nitrogen-containing heteroaromatic. For example, the organic cation can be obtained from a straight chain, a branched, or a cyclic amine. In particularly, the organic cation is obtained from an alkyl amine (e.g., triethylamine (Et₃N), 1,4-diazoniabicyclo[2,2,2]octane), an aryl amine, or a heteroaromatic (e.g., pyridine), where each of the alkyl, aryl, and heteroaromatic optionally is substituted with one or more substituents, each of which independently is described herein. In certain embodiments, the fluorinating source includes an inorganic cation as the counter ion. The anion in these organic salts can be fluoride (F⁻) or tetrafluoroborate (BF₄⁻).

In some embodiments, the fluorinating source includes a fluorinated compound. For example, the fluorinated compound can be an organic fluoride. In certain embodiments, the fluorinated compound includes a compound generally used in a fluorination reaction. For example, the fluorinated compound can be (PhSO₂)₂NF (NFSI), N-fluoro-o-benzenedisulfonimide (NFOBS), Et₂NSF₃ (DAST), (MeOCH₂CH₂)₂NSF₃ (Deoxofluor®), 1-chloromethyl-4-fluoro-1,4-diazoniabicyclo[2,2,2]octane bis(tetrafluoroborate) (Selectfluor®), 4-tert-butyl-2,6-dimethylphenylsulfur trifluoride (Fluolead®), N-fluoropyridinium triflate, or N-fluoropyridinium tetrafluoroborate.

In some embodiments, the fluorinating source includes a fluoride complex. The fluoride complex can be prepared from hydrogen fluoride or a fluoride salt. In some embodiments, the fluorinating source includes hydrogen fluoride and a fluoride complex. In some embodiments, the fluorinating source includes a fluoride salt and a fluoride complex. In particular embodiments, the fluorinating source includes a fluoride salt and a fluoride complex.

In various embodiments, the fluorinating source is hydrogen fluoride, fluorine (F₂), LiF, KF, NaF, CsF, AgF, CuF₂, FClO₃, SF₄, XeF₂, AcOF, (PhSO₂)₂NF, Et₂NSF₃, Et₃N.(HF)₂₋₅, Et₄NF.(HF)₂₋₅, Et₄N.BF₄, (PhSO₂)₂NF (NFSI), N-fluoro-o-benzenedisulfonimide (NFOBS), Et₂NSF₃ (DAST), (MeOCH₂CH₂)₂NSF₃ (Deoxofluor™), 1-chloromethyl-4-fluoro-1,4-diazoniabicyclo[2,2,2]octane bis(tetrafluoroborate) (Selectfluor®), 4-tert-butyl-2,6-dimethylphenylsulfur trifluoride (Fluolead®), N-fluoropyridinium triflate, or N-fluoropyridinium tetrafluoroborate. In some embodiments, the fluorinating source is hydrogen fluoride, LiF, KF, NaF, CsF, Et₃N.(HF)₂₋₅, Et₄NF.(HF)₂₋₅, or Et₄N.BF₄. In certain embodiments, the fluorinating source is hydrogen fluoride. In certain embodiments, the fluorinating source is KF. In certain embodiments, the fluorinating source is CsF. In certain embodiments, the fluorinating source is Et₃N.(HF)₂₋₅. In certain embodiments, the fluorinating source is Et₄NF.(HF)₂₋₅. In certain embodiments, the fluorinating source is Et₄N.BF₄.

In various embodiments, the reaction mixture includes a phase transfer additive. For example, the phase transfer additive can include an ether, a quaternary ammonium salt, or a quaternary phosphonium salt. In some embodiments, the reaction mixture includes a crown ether. In some embodiments, the reaction mixture includes a polyether. In certain embodiments, the reaction mixture includes dimethoxyethane (DME). In some embodiments, the reaction mixture includes a polyethylene glycol. In certain embodiments, the reaction mixture includes diethylene glycol, triethylene glycol, tetraethylene glycol, pentaethylene glycol, hexaethylene glycol, PEG 200, PEG 300, or PEG 400. In particular embodiments, the reaction mixture includes triethylene glycol, tetraethylene glycol, or PEG 200.

In various embodiments, the reaction mixture includes an electrolyte phase. For example, the electrolyte phase includes hydrogen fluoride and an amount of substrate. In some embodiments, the substrate is soluble or dispersible in liquid hydrogen fluoride. The substrate can be in the form of a liquid, solid, or gaseous vapor, and can be introduced to the hydrogen fluoride as appropriate for its physical state. Thus, in some embodiments, a gaseous substrate is introduced by bubbling the substrate through the hydrogen fluoride, or charging the substrate to the cell under pressure. In some embodiments, a solid or liquid substrate is dissolved or dispersed in the hydrogen fluoride. In some embodiments, a substrate is introduced to the cell as a solute dissolved in a fluorochemical phase, as described herein in further details.

While not wishing to be bound by any particular theory, a fluorochemical phase is believed to act as a “reservoir” for a substrate which has relatively poor solubility in the anhydrous hydrogen fluoride electrolyte, but much higher solubility in the fluorochemical phase. Amounts of substrate beyond that which can be dissolved in the hydrogen fluoride phase will be dissolved by the fluorochemical phase, thus preventing the substrate from accumulating separately in the cell and forming a substrate phase.

In various embodiments, a fluorochemical phase includes any fluorochemical material that allows relatively higher solubility of the substrate than does the electrolyte phase (HF), thus dissolving substrate that is not able to be dissolved by the HF phase, and thereby preventing the formation of a separate substrate phase. For example, the fluorochemical phase can comprise the electrochemical fluorination product.

In various embodiments, a fluorochemical phase in the present teachings is a perfluorochemical. For example, the fluorochemical phase can include a perfluoroalkane, a pentafluorosulfanyl-substituted perfluoroalkane, a perfluorocycloalkane, a perfluoroamine, a perfluoroether, a perfluoropolyether, a perfluoroaminoethers a perfluoroalkanesulfonyl fluoride, or a perfluorocarboxylic acid fluoride. In some embodiments, the fluorochemical phase includes a perfluoroalkane. In some embodiments, such compounds can contain some hydrogen or chlorine, e.g., preferably less than one atom of either hydrogen or chlorine for every two carbon atoms, but are preferably substantially completely fluorinated. In certain embodiments, the fluorochemical phase includes perfluorobutane, perfluoroisobutane, perfluoropentane, perfluoroisopentane, perfluorohexane, perfluoromethylpentane, perfluoroheptane, perfluoromethylhexane, perfluorodimethylpentane, perfluorooctane, perfluoroisooctane, perfluorononane, perfluorodecane, 1-pentafluorosulfanylperfluorobutane, 1-pentafluorosulfanylperfluoropentane, 1-pentafluorosulfanylperfluorohexane, perfluorocyclobutane, perfluoro(1,2-dimethylcyclobutane), perfluorocyclopentane, perfluorocyclohexane, perfluorotrimethylamine, perfluorotriethylamine, perfluorotripropylamine, perfluoromethyldiethylamine, perfluorotributylamine, perfluorotriamylamine, perfluoropropyltetrahydrofuran, perfluorobutyltetrahydrofuran, perfluoropoly(tetramethylene oxide), perfluoro(N-methylmorpholine), perfluoro(N-ethylmorpholine), perfluoro(N-propylmorpholine), perfluoropropanesulfonyl fluoride, perfluorobutanesulfonyl fluoride, perfluoropentanesulfonyl fluoride, perfluorohexanesulfonyl fluoride, perfluoroheptanesulfonyl fluoride, perfluorooctanesulfonyl fluoride, perfluorohexanoyl fluoride, perfluorooctanoyl fluoride, or perfluorodecanoyl fluoride.

In various embodiments, the fluorochemical phase is introduced to the ECF cell as described herein as a separate charge or a continuous feed. In some embodiments, the fluorochemical phase is introduced as a separate charge.

In various embodiments, the ratio of HF to substrate is in the range from about 1:1 to about 5000:1. In some embodiments, the ratio of HF to substrate is from about 75:25 to about 2000:1. In certain embodiments, the ratio of HF to substrate is from about 90:1 to about 2000:1. In certain embodiments, the ratio of HF to substrate is from about 100:1 to about 1500:1. In certain embodiments, the ratio of HF to substrate is from about 100:1 to about 1000:1. In certain embodiments, the ratio of HF to substrate is from about 100:1 to about 800:1. In certain embodiments, the ratio of HF to substrate is from about 100:1 to about 600:1. In certain embodiments, the ratio of HF to substrate is from about 100:1 to about 400:1.

In various embodiments, the reaction solution includes an electrolytic component. Without wishing to be bound to any particular theory, the electrolytic component assists passage of electric current through the reaction solution. For example, the electrolytic component can include an organic compound or an inorganic compound. In some embodiments, the electrolytic component includes a mercaptan, an ester, an anhydride, a disulfide, or an ionic salt. In certain embodiments, the electrolytic component includes butyl mercaptan, methyl mercaptan, dimethyl disulfide, or a fluoride salt. In particular embodiments, the electrolytic component includes potassium fluoride or lithium fluoride. Other usefully conductive compounds may also be used in an electrochemical fluorination according to the present teachings.

In various embodiments, the electrolytic component is added to the reaction solution at any amount that will result in a reaction solution sufficiently conductive to allow fluorination of the substrate. For example, the minimum amount of electrolytic component may be preferred as long as a useful amount of electric conductivity of the reaction solution is achieved. In some embodiments, the electrolytic component is in an amount of less than 20 weight percent of the amount of substrate. In certain embodiments, the electrolytic component is in an amount of less than about 10 weight percent of the amount of substrate. In particular embodiments, the electrolytic component is in an amount of less than about 5 weight percent of the amount of substrate.

In various embodiments, the reaction solution includes a solvent. For example, the solvent can be any solvent that dissolves the substrate and is substantially inert to the fluorination. In some embodiments, the solvent comprises acetonitrile, nitromethane, an ether, or a halogenated solvent. In certain embodiments, the solvent comprises acetonitrile. In certain embodiments, the solvent comprises 1,2-dimethoxyethane. In certain embodiments, the solvent comprises methylene chloride. In certain embodiments, the solvent comprises nitromethane. In certain embodiments, the solvent comprises a fluorinated solvent.

In general, the electrochemical fluorination is conducted at any temperature that allows a useful degree of fluorination of the substrate. In various embodiments, the electrochemical fluorination is conducted at a temperatures in the range from about −20° C. to about 80° C. In some embodiments, the electrochemical fluorination is conducted at a temperatures in the range from about 20° C. to about 65° C. In certain embodiments, the electrochemical fluorination is conducted at from about 20° C. to about 40° C. In certain embodiments, the electrochemical fluorination is conducted at from about 20° C. to about 30° C. In certain embodiments, the electrochemical fluorination is conducted at from about 20° C. to about 25° C. In certain embodiments, the electrochemical fluorination is conducted at from about 20° C. to about 23° C. (which sometimes is referred to as the “ambient temperature”). In particular embodiments, the electrochemical fluorination is conducted at about 20° C. In particular embodiments, the electrochemical fluorination is conducted at about 21° C. In particular embodiments, the electrochemical fluorination is conducted at about 22° C. In particular embodiments, the electrochemical fluorination is conducted at about 23° C. In particular embodiments, the electrochemical fluorination is conducted at about 24° C. In particular embodiments, the electrochemical fluorination is conducted at about 25° C. In particular embodiments, the electrochemical fluorination is conducted at about 30° C. In particular embodiments, the electrochemical fluorination is conducted at about 35° C.

In various embodiments, the electrochemical fluorination is conducted at a pressure in the range from about ambient (atmospheric) pressure to about 65 psig (4.48×10⁵ Pa). In some embodiments, the electrochemical fluorination is conducted at a pressure in the range from about 5 to about 45 psig (about 0.34×10⁵ to 3.10×10⁵ Pa). In some embodiments, the electrochemical fluorination is conducted at pressures outside of these ranges.

The electricity passed through the reaction solution can be any amount, as described by parameters including the current, voltage, and power of the electricity, that will result in fluorination of the substrate. In various embodiments, the electric current of the electrochemical fluorination is substantially constant at least during certain period of the reaction. In some embodiments, the electric current of the electrochemical fluorination is substantially constant at least for the half of the reaction.

In various embodiments, the electric current of the electrochemical fluorination is interrupted. For example, the electric current of the electrochemical fluorination is periodic. In some embodiments, the electric current of the electrochemical fluorination is in a cycle. In certain embodiments, the electric current of the electrochemical fluorination is a square wave, a substantially square wave, a sinusoidal wave, or another periodic cycle. In particular embodiments, the electric current of the electrochemical fluorination is a square wave or a substantially square wave.

In various embodiments, the electric voltage of the electrochemical fluorination is substantially constant for at least a certain period of the reaction. In various embodiments, the electric voltage of the electrochemical fluorination is substantially constant for at least half of the reaction.

In various embodiments, the electric voltage of the electrochemical fluorination is interrupted. For example, the electric voltage of the electrochemical fluorination is periodic. In some embodiments, the electric voltage of the electrochemical fluorination is in a cycle. In certain embodiments, the electric voltage of the electrochemical fluorination is a square wave, a substantially square wave, a sinusoidal wave, or another periodic cycle. In particular embodiments, the electric voltage of the electrochemical fluorination is a square wave or a substantially square wave.

In various embodiments, the power of the electricity of the electrochemical fluorination is substantially constant for at least a certain period of the reaction. In various embodiments, the power of the electricity of the electrochemical fluorination is substantially constant for at least half of the reaction.

In various embodiments, the power of the electricity of the electrochemical fluorination is interrupted. For example, the power of the electricity of the electrochemical fluorination is periodic. In some embodiments, the power of the electricity of the electrochemical fluoridation is in a cycle. In certain embodiments, the power of the electricity of the electrochemical fluorination is a square wave, a substantially square wave, a sinusoidal wave, or another periodic cycle. In particular embodiments, the power of the electricity of the electrochemical fluorination is a square wave or a substantially square wave.

Periodic current cycle can be effected by any known and useful method of controlling electricity in an electrochemical fluorination cell. Because cell resistance in an electrochemical fluorination cell is relatively constant, current can be periodically cycled by controlling any one of the electric voltage across the reaction solution, the power flowing through the reaction solution, or the current flowing through the reaction solution, whichever is the most convenient. Generally, the electrical parameter that is easiest to control is the voltage applied across a fluorination cell. Thus, while all possible methods of providing cycled current in an electrochemical fluorination cell are contemplated within the present teachings, portions of the description will be described in terms of controlling the voltage applied across a reaction solution, in a manner to provide (given a relatively stable cell resistance) a periodically cycled current, and a similarly periodically cycled electric power flowing through the reaction solution.

In various embodiments, the electricity flowing through the electrochemical fluorination includes a first current densities. In some embodiments, the first current densities of the electrochemical fluorination are from about 1 to about 400 mA/cm². In certain embodiments, the first current densities of the electrochemical fluorination are from about 100 to about 200 mA/cm². In certain embodiments, the first current densities of the electrochemical fluorination are from about 10 to about 100 mA/cm². In certain embodiments, the first current densities of the electrochemical fluorination are from about 1 to about 10 mA/cm². In particular embodiments, the first current densities of the electrochemical fluorination are about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, or about 30 mA/cm². In particular embodiments, the first current densities of the electrochemical fluorination are about 100, about 105, about 110, about 115, about 120, about 125, about 130, about 135, about 140, about 145, about 150, about 155, about 160, about 165, about 170, about 175, about 180, about 185, about 190, about 195, or about 200 mA/cm².

In various embodiments, the electricity flowing through the electrochemical fluorination includes a second current densities. In some embodiments, the second current densities of the electrochemical fluorination are substantially zero. For example, the second current densities of the electrochemical fluorination are in the range from about 0 to about 2 mA/cm².

In various embodiments, the electricity flowing through the electrochemical fluorination includes a first voltage. In various embodiments, the electricity flowing through the electrochemical fluorination includes a second voltage. In some embodiments, the first voltage is in a range from about 4.2 to about 9 volts (V). In certain embodiments, the first voltage is in the range from about 4.5 to about 6 V. In various embodiment, the second voltage is any voltage that will result in substantially no current flowing through the reaction solution. In various embodiments, the first voltage is substantially constant. In various embodiments, the first voltage varies throughout a pulse cycle.

Generally, the electric current flowing through the electrochemical fluorination can be controlled by any control means useful to provide a periodically interrupted electric current through the reaction solution. Many such control means will be understood by those skilled in the art of electricity and electrochemical fluorination. In various embodiments, the electric voltage applied across the reaction solution is periodically interrupted (i.e., reduced) by connecting the anode and cathode to a power supply having a cycle timer with two predetermined voltage set points, one set point corresponding to an elevated voltage and another set point corresponding to a reduced voltage. In various embodiments, the timer cycles between these two set points at preselected timing intervals. In some embodiments, a periodically cycled current through the reaction solution is achieved by controlling the current by use of a programmable logic controller (PLC) on a power supply.

In various embodiments, the cycle of the electrical current flowing through the electrochemical fluorination is 0.4, 1.5, 3, 10, 30, 150, or 300 seconds.

In various embodiments, the electrochemical fluorination takes from about 0.1 hour to about 50 hours. For example, an electrochemical fluorination of the present teachings can take about 0.1, about 0.2, about 0.3, about 0.4, about 0.5, about 0.6, about 0.7, about 0.8, about 0.9, about 1, about 2, about 3, about 4, about 5, about 6, about 7, about 8, about 10, about 11, about 12, about 13, about 14, about 15, about 16, about 17, about 18, about 19, about 20, about 21, about 22, about 23, or about 24 hours. In some embodiments, the electrochemical fluorination takes for about 0.2 hour. In some embodiments, the electrochemical fluorination takes for about 0.4 hour. In some embodiments, the electrochemical fluorination takes for about 0.5 hour. In some embodiments, the electrochemical fluorination takes for about 1 hour. In some embodiments, the electrochemical fluorination takes for about 5 hours. In some embodiments, the electrochemical fluorination takes for about 10 hours. In some embodiments, the electrochemical fluorination takes for about 20 hours. In some embodiments, the electrochemical fluorination takes for about 22 hours.

In various embodiments, the electrochemical fluorination is allowed to proceed until a certain conversion is reached. In some embodiments, the conversion is at least 5%. In some embodiments, the conversion is at least 10%. In some embodiments, the conversion is at least 20%.

In various embodiments, the electrochemical fluorination is allowed to proceed until a product is produced. As discussed in detail herein, an electrochemical fluorination is monitored by using an analytical method, which can be an LC-MS. For instance, the mass spectroscopy in the present teachings can be used as a detector and the detecting masses can be set at the mass of the substrate (MW) and the mass of the substrate plus 18 (MW+18). In some embodiments, the electrochemical fluorination is allowed to proceed until a product is detected.

An aspect of the present teachings is mono-fluorinated compounds obtained by using a method described herein. Without wishing to be bound by any particular theory, ECF can produce compounds where one or more hydrogens that are attached to carbon are replaced by one or more fluorine atoms; and without wishing to be bound by any particular theory, ECF can produce compounds where the fluorine substitutions are not predictable. However, in various embodiments, the conditions of an ECF of the present teachings are adjusted so that mono-fluorinated compounds (i.e., each of which has only one carbon-bound hydrogen replaced by fluorine) are produced. In some embodiments, the ECF produces one mono-fluorinated compound. In some embodiments, the ECF produces two mono-fluorinated compound. In some embodiments, the ECF produces three or more mono-fluorinated compounds.

In various embodiments, the electrochemical fluorination is allowed to proceed before other products are detected. In some embodiments, the other products include mono-fluorinated compounds. In some embodiments, the other products include di-fluorinated compounds. In some embodiments, the other products include multi-fluorinated compounds. In certain embodiments, the other products include derivatives of a mono-fluorinated compound, a di-fluorinated compound, or a multi-fluorinated compound.

As discussed herein, in certain embodiments, the electrochemical fluorination is allowed to proceed for about 5 hours. In certain embodiments, the electrochemical fluorination is allowed to proceed for about 10 hours. In certain embodiments, the electrochemical fluorination is allowed to proceed for about 20 hours. In certain embodiments, the electrochemical fluorination is allowed to proceed for about 25 hours.

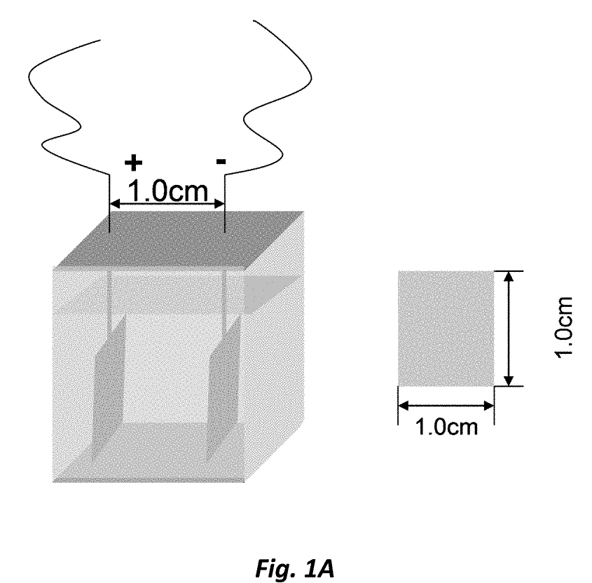

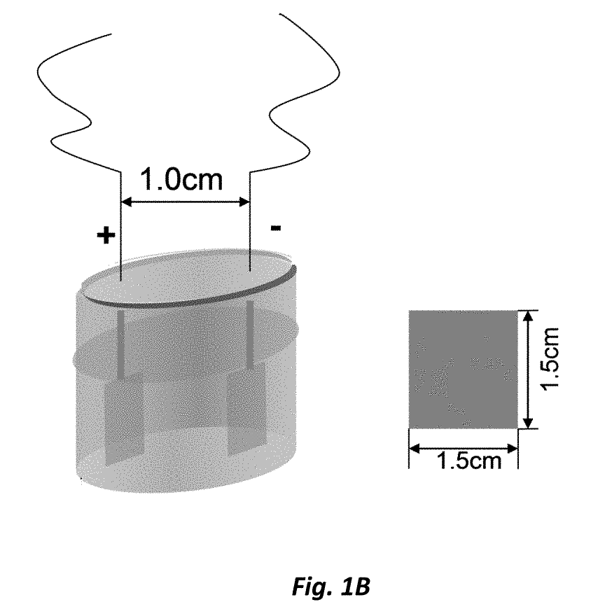

Electrochemical fluorination cells in which the electrochemical fluorination can be performed (also referred to herein as the “cell,” the “fluorination cell,” or the “ECF cell”) may be any conventional electrochemical fluorination cell known in the art of electrochemical fluorination. In general, a suitable fluorination cell can be constructed of components including a cell body comprising a reaction vessel capable of containing the reaction solution, and electrodes that may be submerged into the reaction solution for the passage of current through the reaction solution. Electrochemical fluorination cells that can be useful in the practice of the present teachings are described, for example, in U.S. Pat. No. 2,519,983, GB 741,399 and 785,492. Without wishing to be bound by the following examples, FIGS. 1A and 1B illustrate two exemplary ECF cells. In FIG. 1A, the ECF cell includes a cuboid reaction vessel. In FIG. 1B, the ECF cell includes a cylindrical reaction vessel. In various other embodiments, the ECF cell includes a reaction vessel in other shape as long as the electrochemical fluorination can be carried out.

In various embodiments, a reaction vessel of the present teachings is constructed to contain any volumes of the reaction solution. In some embodiments, the reaction vessel has an effective volume of about 0.5 mL, about 1 mL, about 2 mL, about 5 mL, about 10 mL, or about 15 mL. In certain embodiments, the reaction vessel has an effective volume of about 1 mL.

In various embodiments, an ECF cell of the present teachings is constructed with Teflon® or other materials that are resistant to hydrogen fluoride. In some embodiments, the ECF cell is constructed with Teflon®.

Other useful electrochemical fluorination cells include the type generally known in the electrochemical fluorination art as flow cells. Flow cells include a set (one of each), stack, or series of anodes and cathodes, where the reaction solution is caused to flow over the surfaces of the anodes and cathodes using forced circulation. These types of flow cells are generally referred to as monopolar flow cells (having a single anode and a single cathode, optionally in the form of more than a single plate, as with a conventional electrochemical fluorination cell), and, bipolar flow cells (having a series of anodes and cathodes).

In various embodiments, the anode is made of a material including Al, Co, Cr, Cu, Mg, Ti, Zn, Zr, Fe, Co, Ni, Pt, or an alloy comprising thereof. In some embodiments, the anode is made of a material including Fe, Co, Ni, Pt, or an alloy comprising thereof. In certain embodiments, the anode is made of a material including Ni or Pt. In particular embodiments, the anode includes Ni. In particular embodiments, the anode includes Pt.

In various embodiments, the cathode is made of a material including Ni, Fe, Cu, Pt, an alloy comprising thereof, or C. In some embodiments, the cathode is made of a material including Ni or Pt. In certain embodiments, the cathode includes Ni. In certain embodiments, the cathode includes Pt.

A substrate of the present teachings can be introduced into an ECF cell in any sequence as long as it is practical. In various embodiments, a substrate of the present teachings is added into an ECF cell containing anhydrous hydrogen fluoride. In various embodiments, a substrate of the present teachings and anhydrous hydrogen fluoride are added into an ECF cell simultaneously. In various embodiments, a substrate of the present teachings is added into an ECF cell followed by the addition of anhydrous hydrogen fluoride. In some embodiments, the anhydrous hydrogen fluoride is added as a solution in a fluorochemical phase. In some embodiments, the substrate is added as a solution in a fluorochemical phase. In some embodiments, the substrate optionally as a solution in the fluorochemical phase is added into the ECF cell.

The reaction mixture can be screened against a variety of properties. In various embodiments, the reaction mixture is screened for the affinity or the activity toward a biological target, human microsomal stability, PAMPA permeability, plasma protein binding, blood brain barrier (BBB) penetration, or the solubility in a drug formulation. In some embodiments, the reaction mixture is screened for the affinity toward a biological target that is used in screening the substrate. In some embodiments, the reaction mixture is screened for the affinity toward a biological target that is not used in screening the substrate.

The biological target can include, by way of example, proteins, including recombinant proteins, glycoproteins, glycosaminoglycans, proteoglycans, integrins, enzymes, lectins, selecting, cell-adhesion molecules, toxins, bacterial pili, transport proteins, receptors involved in signal transduction or hormone-binding, hormones, antibodies, major histocompatability complexes, immunoglobulin superfamilies, cadherins, DNA or DNA fragments, RNA and RNA fragments, whole cells, cell fragments, tissues, bacteria, fungi, viruses, parasites, preons, and synthetic analogs or derivatives thereof. In certain embodiments, the biological target includes a protein or a fragment thereof. In particular embodiments, the protein is a kinase, a protease, a peptidase, a nuclear hormone receptor, a protein complex, a G-protein coupled receptor (GPCR), a protein-protein interaction target, or a transcription factor.

In various embodiments, the reaction mixture is screened directly, which means that the reaction mixture is contacted with a biological target and the resulting complexes are detected by using a detection method. For example, a component in the reaction mixture can form a covalent or a non-covalent complex with the biological target and these complexes can be detected by using a variety of mass spectrometry (MS)-based method. In some embodiments, the detection method is fragment-based lead assembly, nano-electrospray-MS, multi-target affinity/specificity screening, detection of oligonucleotide-ligand complexes by electrospray ionization (ESI)-MS (DOLCE-MS), or ESI-electron capture dissociation, each of which is generally known to a person with ordinary skill in the art.

For affinity studies one may also use affinity separation techniques including: ultrafiltration, size-exclusion chromatography, dialysis, and/or affinity chromatography. These various affinity separation techniques are described in Wanner, K. et al., Mass Spectrometry in Medicinal Chemistry: Applications in Drug Discovery, Volume 36, Wiley 2007; and Comess, K. M. and Schurdak, M. E., Affinity-based screening techniques for enhancing lead discovery, Current Opinion in Drug Discovery & Development 2004, 7 (4), 411-416, each of which is incorporated by reference in its entirety.

These techniques, combined with detection methods such as LC-MS or NMR, may be used to determine the relative affinity of mixture components. For activity measurements of a mixture, one may use LC-MS in combination with an on-line bioreactor, one of which is described in van Liempd, S. M., et al. On-line Formation, Separation, and Estrogen Receptor Affinity Screening of Cytochrome P450-Derived Metabolites of Selective Estrogen Receptor Modulators, Drug Metabolism and Disposition, 2006, 34 (9), 1640-1649; and de Jong, C. F., et al. High-performance liquid chromatography-mass spectrometry-based acetylcholinesterase assay for the screening of inhibitors in natural extracts, Journal of Chromatography A, 2006, 1112, 303-310, each of which is incorporated by reference in its entirety.

Thus, in various embodiments, the reaction mixture is screened by using an automated ligand identification system (ALIS), SpeedScreen, a frontal affinity chromatography with MS detection, an affinity capture-MS, an affinity capillary electrophoresis-MS, an ultra-filtration-MS, or a pulsed ultra-filtration-MS, each of which is generally known to a person with ordinary skill in the art. In some embodiments, the reaction mixture is screened by using a MiniSpin™ column.

For human liver microsomal stability experiment, one may incubate a reaction mixture of the present teachings with human liver microsome preparation and measure concentration of the mixture components with LC-MS or NMR before and after incubation.

For PAMPA permeability, which is an indication of the drug's ability to be absorbed by the intestinal system when taken orally, one may use specialized PAMPA plate for compound permeability and use LC-MS to measure compound concentration in two different sides of the PAMPA membrane (apical and basal) to calculate the permeability.

For plasma protein binding, dialysis plates may be used to measure free and bound portion of mixture components with LC-MS measurement.

If a reaction mixture shows desirable properties towards a biological target, the reaction mixture can be purified to identify the component(s) that is responsible for the desirable properties. The properties can include, but not limited to: affinity, activity, human microsomal stability, membrane permeability, plasma protein binding, blood-brain-barrier (BBB) penetration, or solubility in a drug formulation.

In various embodiments, the reaction mixture is purified by a liquid chromatography (LC) to separate each component in the reaction mixture. For example, the LC can be a high pressure LC (HPLC) or a preparative LC (PrepLC). In various embodiments, the each component is identified by MS, optionally connected with MS, which optionally is connected with MS. In certain embodiments, the reaction mixture is separated and the components are identified by LC-MS, LC-MS-MS, or LC-MS-MS-MS. In various embodiments, the reaction mixture is purified by using a PrepLC. MS detection and triggering for compound collection may be used to assist the purification of selected components from the mixture. Blom K. F., et al. Preparative LC-MS purification: improved compound-specific method optimization, J Comb Chem. 2004, 6 (6), 874-83 describes an example of such methods and is incorporated by reference in its entirety.

In various embodiments, the component that has a desirable property is identified by using LC-MS, LC-MS-MS, or LC-MS-MS-MS. In various embodiments, the component that has a desirable property is identified by using other analytical method. For example, the additional analytical method can include a nuclear magnetic resonance or an x-ray diffraction. In the embodiments when larger quantities of reaction mixtures are necessary, the electrochemical fluorination can be scaled-up or repeated to produce enough material for separation.

In various embodiments, the desirable properties include the same property that the substrate possesses. In various embodiments, the desirable properties include the same and improved property that the substrate possesses. In various embodiments, the desirable properties include a different property. In some embodiments, the desirable properties include a different but useful property.

After the structure determination of the desirable components in a reaction mixture of the present teachings, the pure form of the desirable components may be obtained with sufficient amount for in vitro tests to confirm their properties relative to the starting substrate. One may obtain sufficient amount of a repeated or scaled-up electrochemical fluorination as described herein by separation and purification of the mixture or by organic synthesis of the compound when the structure of the compound is fully determined.

After separation and purification to obtain sufficient amount, the desirable components from the reaction mixture from the substrate can be tested individually for confirmation of properties relative to the substrate.

A person with ordinary skills in the art will appreciate that one aspect of the present teachings is the combination of an electrochemical fluorination of a substrate, screening, either directly or indirectly, of the reaction mixture with a biological target, and confirming and/or identifying one or more fluorinated compounds that have desirable and/or improved properties. In various embodiments, such combination facilitates identification of a fluorinated compound with desirable and/or improved properties in a timely manner. Without intending to character any existing drug discovery processes, methods of the present teachings generally accelerate drug discovery processes. For example, it can take no more than 10 days to identify one or more fluorinated compounds with desirable and/or improved properties. In some embodiments, it takes no more than 9 days, 8 days, 7 days, 6 days, 5 days, 4 days, 3 days, 2 days, or one day to modify a substrate with an electrochemical fluorination, screen a mixture of the fluorination, and confirm and/or identify one or more fluorinated compounds with desirable and/or improved properties. In certain embodiments, it takes no more than 3 days, 2 days, or one day to modify a substrate with an electrochemical fluorination, screen a mixture of the fluorination, and confirm and/or identify one or more fluorinated compounds with desirable and/or improved properties. In particular embodiments, it takes no more than 2 days or one day to modify a substrate with an electrochemical fluorination, screen a mixture of the fluorination, and confirm and/or identify one or more fluorinated compounds with desirable and/or improved properties.

Another aspect of the present teachings relates to a component with desirable properties identified by a method of the present teachings. In various embodiments, the component includes a compound. In various embodiments, the component includes two or more compounds.

Another aspect of the present teachings relates to a system used with a method of the present teachings. For example, the system can include LC-MS or LC-MS-MS.

The following examples are intended to illustrate certain embodiments of the present teachings, do not exemplify the full scope of the present teachings, and therefore should not be construed to limit the scope of the present teachings.

### Example 1: Electrochemical Fluorination of Rosiglitazone

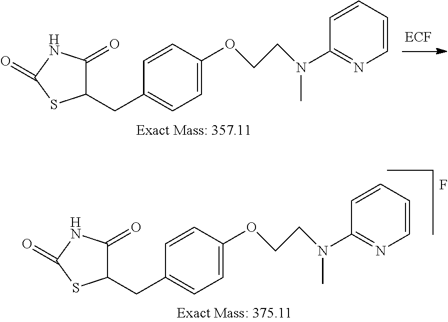

Rosiglitazone (10 mg) was dissolved in 0.3M Et₄NF.4HF in acetonitrile (10 mL). The solution was transferred to a Teflon® ECF cell. Ni electrodes were used and each reaction surface area is ˜2.5 cm². Current (I) was set at 0.05 A. The electrochemical reaction was carried out at the ambient temperature. The reaction was monitored by LC/MS (MW of the Product=18+MW of Rosiglitazone).

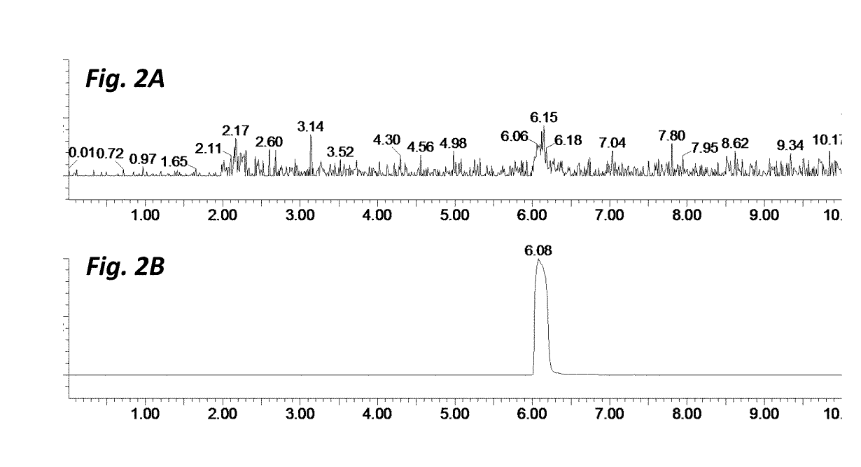

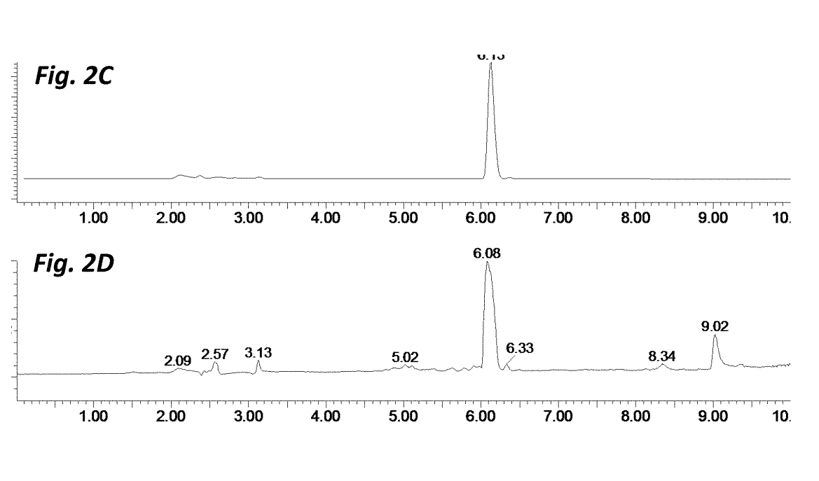

FIGS. 2A and 2B show exemplary LC-MS chromatograms with the MS detector set at (18+H+the molecular weight (MW) of Rosiglitazone) and (H+MW of Rosiglitazone), respectively, of a reaction mixture before the commencement of the reaction. FIGS. 2C and 2D show exemplary LC chromatograms with a diode array detector (DAD) and a MS detector detecting the total ion current, respectively, of a reaction mixture before the commencement of the reaction.

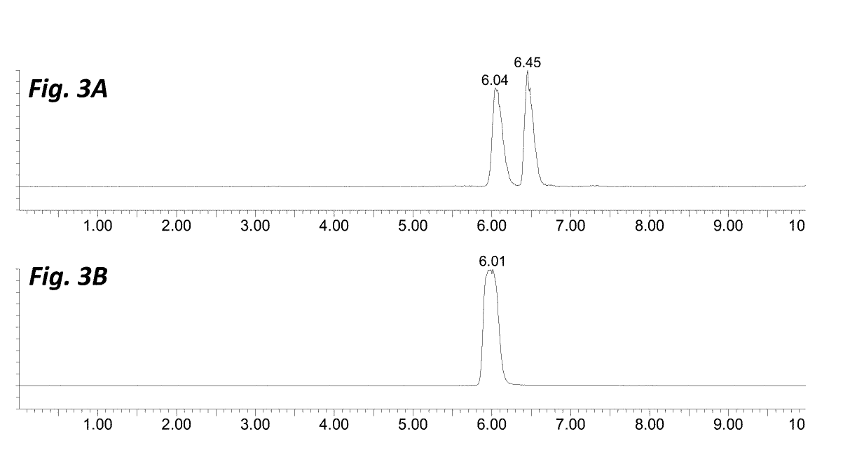

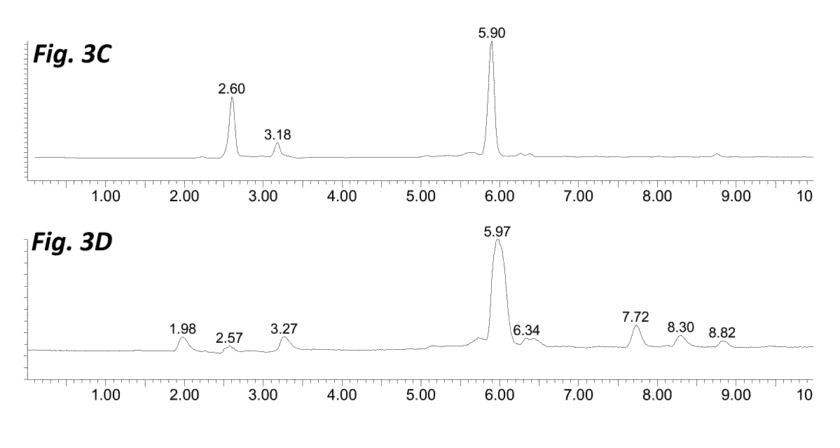

FIGS. 3A and 3B show exemplary LC-MS chromatograms with the MS detector set at (18+H+MW of Rosiglitazone) and (H+MW of Rosiglitazone), respectively, of a reaction mixture 10 hours after the reaction started. FIGS. 3C and 3D show exemplary LC chromatograms with a diode array detector (DAD) and a MS detector detecting the total ion current, respectively, of a reaction mixture 10 hours after the reaction started.

### Example 2: Electrochemical Fluorination of Telmisartan

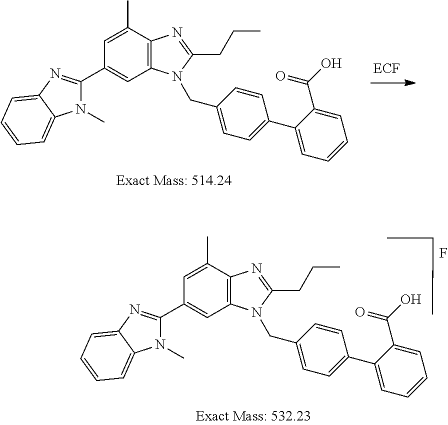

Telmisartan (10 mg) was dissolved in 0.3M Et₄NF.4HF in acetonitrile (10 mL). The solution was transferred to a Teflon® ECF cell. Pt electrodes were used and each reaction surface area is ˜2.5 cm². The reaction current (I) was set at 0.01 A. The electrochemical reaction was carried out at the ambient temperature and was monitored by LC/MS (Product MW=18+Starting material MW).

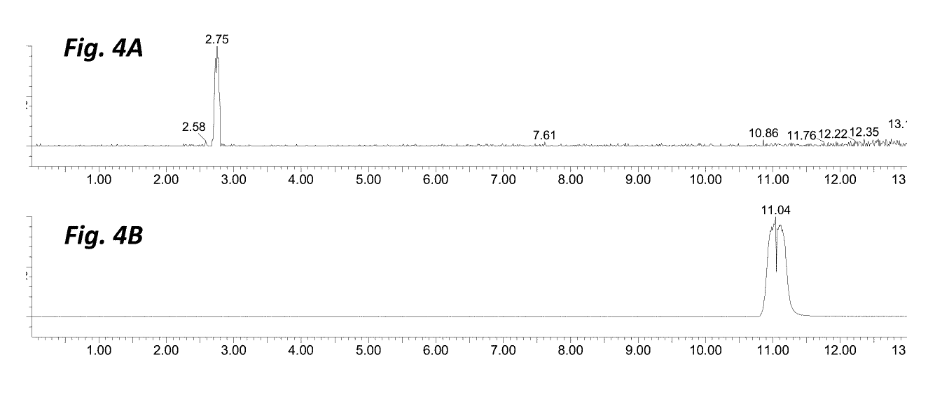

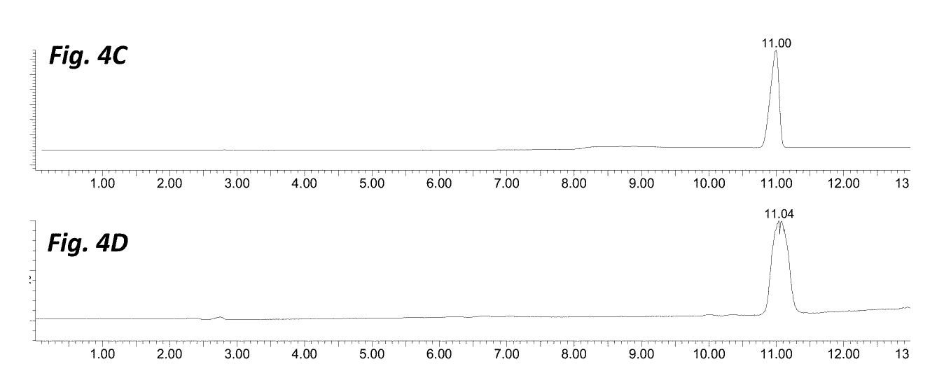

FIGS. 4A and 4B show exemplary LC-MS chromatograms with the MS detector set at (18+H+MW of Telmisartan) and (H+MW of Telmisartan), respectively, of a reaction mixture before the commencement of the reaction. FIGS. 4C and 4D show exemplary LC chromatograms with a diode array detector (DAD) and a MS detector detecting the total ion current, respectively, of a reaction mixture before the commencement of the reaction.

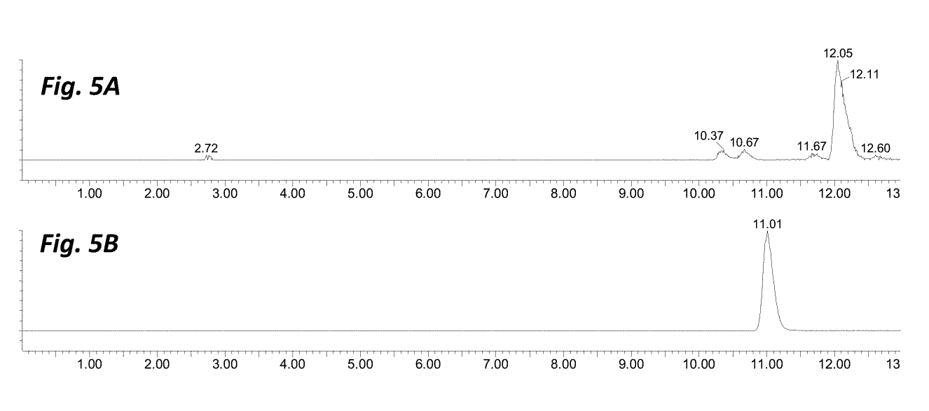

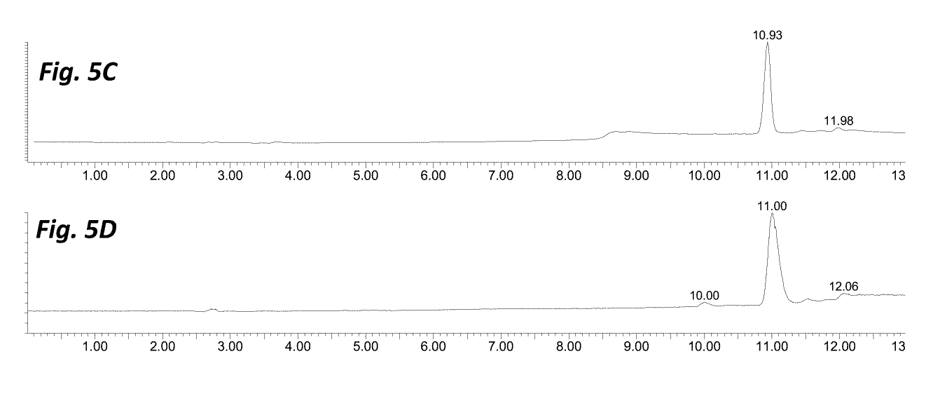

FIGS. 5A and 5B show exemplary LC-MS chromatograms with the MS detector set at (18+H+MW of Telmisartan) and (H+MW of Telmisartan), respectively, of a reaction mixture 22 hours after the reaction started. FIGS. 5C and 5D show exemplary LC chromatograms with a diode array detector (DAD) and a MS detector detecting the total ion current, respectively, of a reaction mixture 22 hours after the reaction started.

### Example 3: Electrochemical Fluorination of Sorafenib

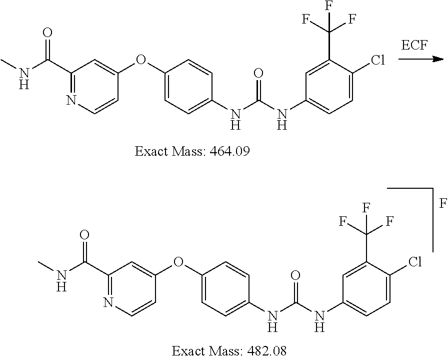

Sorafenib (5 mg) was dissolved in 0.3M Et₄NF.4HF in acetonitrile (10 mL). The solution was transferred to a Teflon® ECF cell. Ni electrodes were used and each reaction surface area is ˜2.5 cm². The current (I) was set at 0.06 A. The ECF reaction was carried out at the ambient temperature and monitored by LC/MS (Product MW=18+Starting material MW).

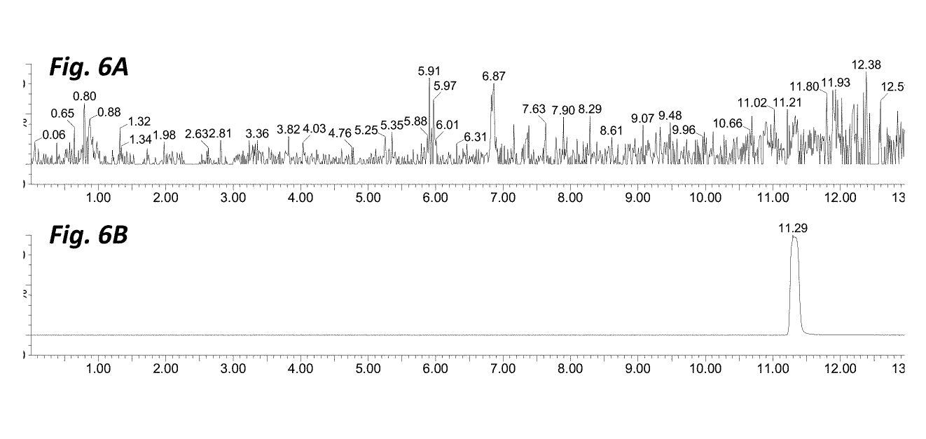

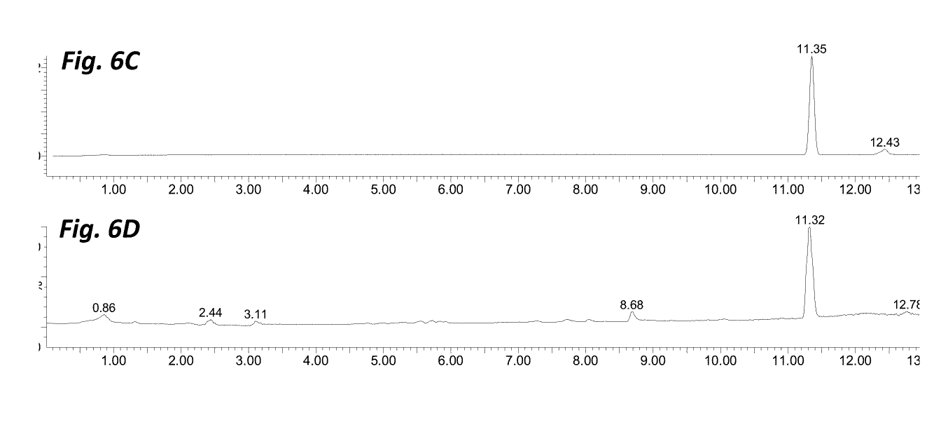

FIGS. 6A and 6B show exemplary LC-MS chromatograms with the MS detector set at (18+H+MW of Sorafenib) and (H+MW of Sorafenib), respectively, of a reaction mixture before the commencement of the reaction. FIGS. 6C and 6D show exemplary LC chromatograms with a diode array detector (DAD) and a MS detector detecting the total ion current, respectively, of a reaction mixture before the commencement of the reaction.

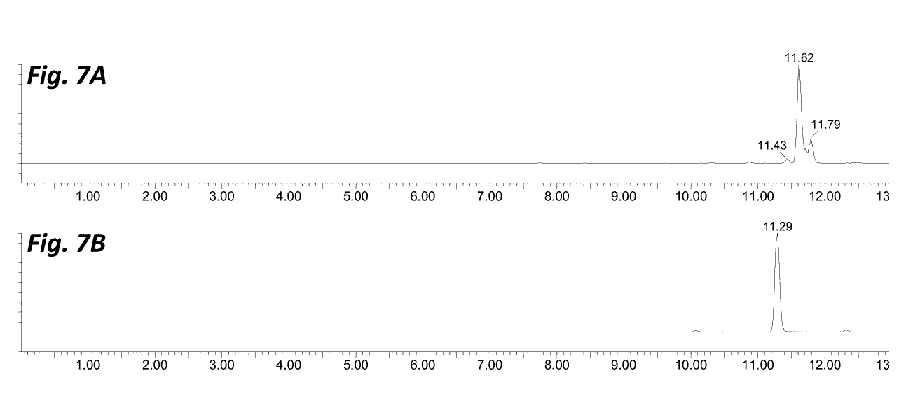

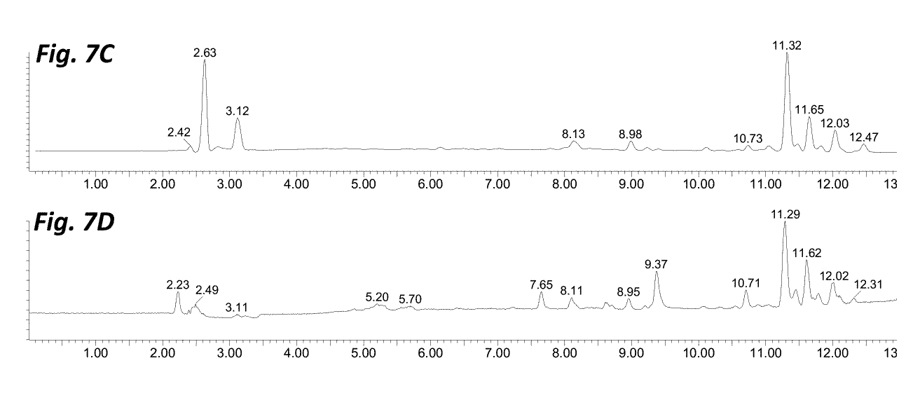

FIGS. 7A and 7B show exemplary LC-MS chromatograms with the MS detector set at (18+H+MW of Sorafenib) and (H+MW of Sorafenib), respectively, of a reaction mixture 10 hours after the reaction started. FIGS. 7C and 7D show exemplary LC chromatograms with a diode array detector (DAD) and a MS detector detecting the total ion current, respectively, of a reaction mixture 10 hours after the reaction started.

By using procedures similar with those described in Examples 1-3, the following compounds were fluorinated:

| | LC-MS | | |
|---|---|---|---|
| | MS (m/z) | | LC |
| | Starting | Mono fluorinated | Mono fluorinated |
| | material | product | product |
| Selected compounds | (M + H) | (M + F + H) | Rf (min) |
| Sorafenib | 464.93 | 482.87 | 11.43, 11.62, 11.79 |
| Erlotinib | 394.01 | 412.02 | 6.33, 6.48 |
| PIK294 | 489.96 | 507.83 | 8.95 |
| PH-797804 | 476.76 | 494.83 | 10.85 |
| WP1066 | 356 | 374 | 10.99 |
| Olanzapine | 312.97 | 330.91 | 5.48 |
| Metaxalone | 222.00 | 239.93 | 8.91 |
| Sotrastaurin | 438.86 | 457.13 | 6.78 |
| R406 (free base) | 470.91 | 488.92 | 10.45 |
| Dabrafenib | 519.86 | 537.74 | 10.75 |
| PF-04691502 | 425.93 | 443.8 | 8 |
| Pazopanib | 437.82 | 455.83 | 7.67 |
| PIK-293 | 397.85 | 415.85 | 7.93 |
| Ibrutinib | 440.88 | 458.88 | 10.45 |
| (PCI-32765) | | | |
| IC-87114 | 397.91 | 415.85 | 7.87 |
| Linezolid | 338.32 | 356.12 | 6.04, 5.73, 6.03 |
| XL147 | 448.94 | 466.95 | 12.48 |
| GDC-0994 | 440.81 | 458.82 | 8.49 |
| Rosiglitazone | 358.01 | 375.95 | 6.04, 6.45 |
| ZSTK474 | 418.2 | 436.2 | 9.46 |
| Lenvatinib | 426.77 | 444.91 | 7.7 |
| Cediranib | 450.89 | 468.93 | 4.62 |
| Brivanib | 370.88 | 388.82 | 10.37 |
| (BMS-540215) | | | |
| Telmisartan | 514.98 | 532.96 | 12.05 |
| Regorafenib | 482.87 | 500.88 | 10.42, 11.16 |
| Tofacitinib | 312.97 | 330.97 | 6.69 |
| Trametinib | 615.68 | 633.69 | 10.73 |
| BKM120 | 411.2 | 429.2 | 9.33 |
| CAL-101 | 416.2 | 434.2 | 8.74 |
| Selumetinib | 458.69 | 476.63 | 8.36 |
| VX-702 | 404.8 | 422.74 | 8.04 |
| Selumetinib | 457 | 475 | 3.91 |
| (AZD6244) | | | |
| Axitinib | 386.97 | 404.97 | 5.01 |
| CUDC-101 | 434.9 | 452.97 | 6.24 |
| Cabozantinib | 501.92 | 519.93 | 10.38 |
| BEZ235 | 470 | 488.01 | 4.91 |
| TG100-115 | 346.83 | 364.83 | 5.99 |
| CGI1746 | 580.2 | 598.21 | 11.4 |
| LY294002 | 308.1 | 326.1 | 3.88 |
| Alisertib | 518.76 | 536.76 | 11.42 |
| JNJ-38877605 | 377.9 | 395.9 | 7.8 |
| Ruxolitinib | 306.99 | 324.84 | 8.81 |
| PKI-402 | 571.28 | 589.28 | 4.33 |
| DF-04691502 | 426.2 | 444.2 | 4.4 |

### Example 4: Affinity Selection-MASS Spectrometry Screening of a Mixture of a ECF Reaction of Sorafenib to VEGFR-2

MiniSpin™ columns (Nest Group) are conditioned with an appropriate PMS buffer. An ECF reaction mixture is mixed with an excess amount of a target protein solution and the resulting mixture is incubated. The mixture of the ECF reaction mixture and the target protein solution is loaded onto the conditioned MiniSpin™ columns, which are centrifuged in a high speed centrifuge. Each of the eluents is analyzed by a LC-MS. The presence of a mono-fluorinated product in the eluents indicates that the mono-fluorinated product binds the target protein and the mono-fluorinated product-target protein complex is eluted from the MiniSpin™ column. Thus, the mono-fluorinated product is a desirable compound.

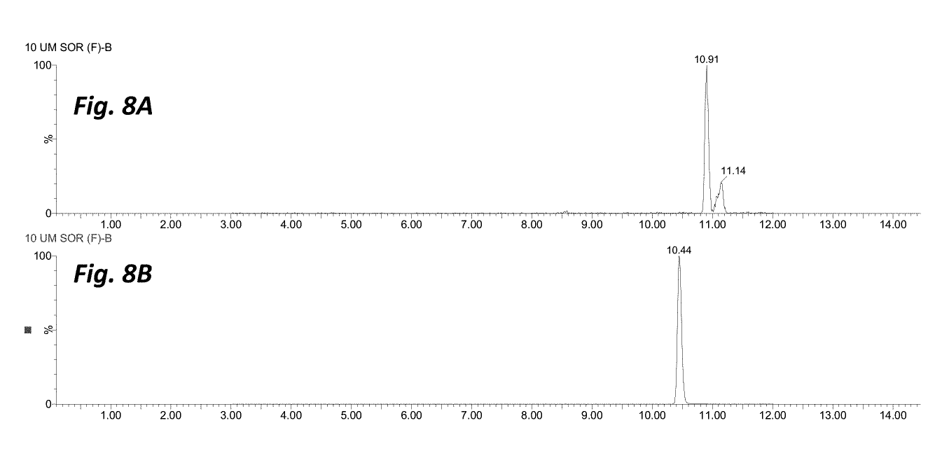

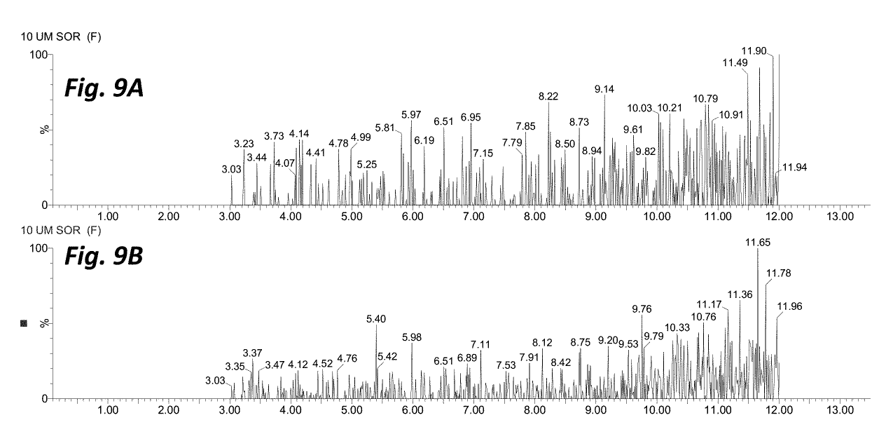

Specifically, 1 uL of fluorinated Sorafenib mixture (above example 3) was mixed with 20 uL phosphate-buffered saline (PBS) buffer. The solution was allowed to stay at RT for 30 min. 20 uL of this solution was added to a PBS buffer-conditioned G-25 spin column (Nest Group). The column was centrifuged at 2000 rpm for 3 min. The eluent was analyzed by LC-MS. FIGS. 8A and 8B show exemplary LC-MS chromatograms with the MS detector set at (18+H+MW of Sorafenib) and (H+MW of Sorafenib), respectively, of a reaction mixture before it was treated with the spin column; and FIGS. 9A and 9B show exemplary LC-MS chromatograms with the MS detector set at (18+H+MW of Sorafenib) and (H+MW of Sorafenib), respectively, of a reaction mixture after it was treated with the spin column. As shown in FIGS. 9A and 9B, neither Sorafenib nor its fluorinated compound was detected in the eluent.

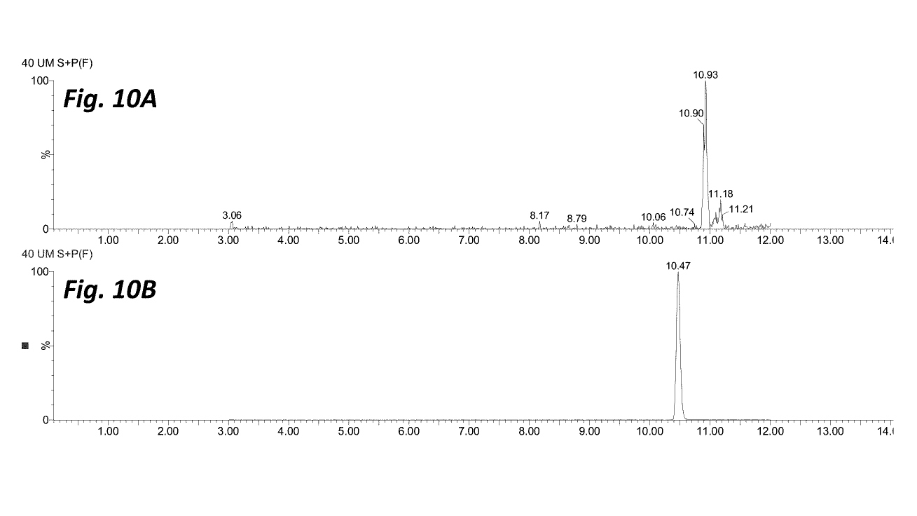

1 uL of fluorinated Sorafenib mixture (above example 3) was mixed with 20 uL of 15 uM VEGFR-2. The solution was incubated at RT for 30 min, then 20 ul of this solution was loaded on to a PBS buffer-conditioned G-25 spin column (Nest Group). The column was centrifuged at 2000 rpm for 3 min. The eluent was used for LC-MS analysis. FIGS. 10A and 10B show exemplary LC-MS chromatograms with the MS detector set at (18+H+MW of Sorafenib) and (H+MW of Sorafenib), respectively, of a reaction mixture after it was treated with the spin column. As shown in FIGS. 10A and 10B, both Sorafenib and its mono-fluorinated compound were detected in the eluent, indicating that both Sorafenib and the mono-fluorinated compound bind with VEGFR-2.

While several embodiments of the present teachings have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present teachings. More generally, those skilled in the art will readily appreciate that all parameters, dimensions, materials, and configurations described herein are meant to be exemplary and that the actual parameters, dimensions, materials, and/or configurations will depend upon the specific application or applications for which the present teachings is/are applied. Those skilled in the art will recognize, or be able to ascertain using no more than routine experimentation, many equivalents to the specific embodiments of the present teachings described herein. It is, therefore, to be understood that the foregoing embodiments are presented by way of example only and that, within the scope of the appended claims and equivalents thereto, the present teachings may be practiced otherwise than as specifically described and claimed. The present teachings are directed to each individual feature and/or method described herein. In addition, any combination of two or more such features and/or methods, if such features and/or methods are not mutually inconsistent, is included within the scope of the present teachings.

The above description of the disclosed embodiments is provided to enable any person skilled in the art to make or use the present teachings disclosed herein. Various modifications to these embodiments will be readily apparent to those skilled in the art, and the generic principles described herein can be applied to other embodiments without departing from the spirit or scope of the present teachings. Thus, it is to be understood that the description and drawings presented herein are representative of the subject matter which is broadly contemplated by the present teachings. It is further understood that the scope of the present teachings is not intended to be limited to the embodiments shown herein but is to be accorded with the widest scope consistent with the patent law and the principles and novel features disclosed herein.

Alternative embodiments of the claimed disclosure are described herein. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the present teachings to be practiced otherwise than as specifically described herein.

Accordingly, this present teachings include all modifications and equivalents of the subject matter recited in the claims appended hereto as permitted by applicable law. Moreover, any combination of the above described elements in all possible variations thereof is encompassed by the present teachings unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A method of identifying a compound comprising
providing a substrate;
modifying the substrate with an electrochemical
fluorination to providing a reaction mixture; and
screening the reaction mixture against a biological target.

2. The method of claim 1, wherein the substrate is a small molecule.

3. The method of claim 1, wherein the substrate is a therapeutic agent.

4-9. (canceled)

10. The method of claim 1 comprising providing a fluorinating source.

11. The method of claim 10, wherein the fluorinating source comprises hydrogen fluoride.

12-14. (canceled)

15. The method of claim 10, wherein the fluorinating source is anhydrous hydrogen fluoride, fluorine (F₂), LiF, KF, NaF, CsF, AgF₂, CuF₂, FClO₃, SF₄, XeF₂, AcOF, (PhSO₂)₂NF, Et₂NSF₃, Et₃N.(HF)₂₋₅, Et₄NF.(HF)₂₋₅, Et₄N.BF₄, (PhSO₂)₂NF (NFSI), N-fluoro-o-benzenedisulfonimide (NFOBS), Et₂NSF₃ (DAST), (MeOCH₂CH₂)₂NSF₃ (Deoxofluor®), 1-chloromethyl-4-fluoro-1,4-diazoniabicyclo[2,2,2]octane bis(tetrafluoroborate) (Selectfluor®), 4-tert-butyl-2,6-dimethylphenylsulfur trifluoride (Fluolead®), N-fluoropyridinium triflate, or N-fluoropyridinium tetrafluoroborate.

16. (canceled)

17. The method of claim 1 comprising preparing a reaction solution comprising a phase transfer additive.

18. The method of claim 17, wherein the reaction solution comprises an electrolytic phase.

19. The method of claim 18, wherein the reaction solution comprises a fluorochemical phase.

20-21. (canceled)

22. The method of claim 1, wherein the electrochemical fluorination is conducted between a cathode and an anode.

23. The method of claim 22, wherein the cathode is made of a material comprising Ni, Fe, Cu, Pt, an alloy thereof, or C.

24. The method of claim 22, wherein the anode is made of a material comprising Al, Co, Cr, Cu, Mg, Ti, Zn, Zr, Fe, Co, Ni, Pt, or an alloy thereof.

25-26. (canceled)

27. The method of claim 1, wherein the electrochemical fluorination is conducted with a cyclic electric current.

28. The method of claim 1, wherein the electrochemical fluorination is conducted with a constant electric current.

29. The method of claim 1, wherein the electrochemical fluorination is conducted until at least one mono-fluorinated compound is detected.

30. (canceled)

31. The method of claim 1, wherein the screening comprises contacting the reaction mixture with a biological target.

32. The method of claim 31, wherein the biological target is a protein.

33-37. (canceled)

38. The method of claim 1, comprising confirming biological activity of the fluorinated compound.

39. A compound identified by the method of claim 1.

40. A system used in the method of claim 1.
